(19) United States
(12) Patent Application Publication
(10) Pub. No.: US 2025/0026444 A1
(43) Pub. Date: Jan. 23, 2025

(54) Steering Systems for Snowmobiles

(71) Applicant: Arctic Cat Inc., Thief River Falls, MN (US)

(72) Inventors: Guy L. Sibilleau, Roseau, MN (US); David L. Vigen, Thief River Falls, MN (US)

(73) Assignee: Arctic Cat Inc., Thief River Falls, MN (US)

(21) Appl. No.: 18/669,805

(22) Filed: May 21, 2024

Related U.S. Application Data
(60) Provisional application No. 63/528,374, filed on Jul. 22, 2023.

(51) Int. Cl. B62M 27/02

(52) U.S. Cl. CPC B62M 27/02; B62M 2027/023; B62M 2027/025; B62M 2027/028

(57) ABSTRACT

A steering system for a snowmobile includes a handlebar assembly and a steering column that has upper and lower ends. The upper end of the steering column is coupled to the handlebar assembly. The lower end of the steering column is coupled to an input shaft of an electronic steering assist unit. An output shaft of the electronic steering assist unit is coupled directly to a steering arm assembly. First and second tie rods respectively couple the steering arm assembly to first and second ski assemblies such that turning the handlebar assembly, together with the assistance of the electronic steering assist unit, causes the ski assemblies to pivot. The steering column and the electronic steering assist unit share a common axis of rotation that is positioned along a centerline of the snowmobile.

### CROSS-REFERENCE TO RELATED APPLICATIONS

The present application claims the benefit of U.S. Provisional Application No. 63/528,374, filed Jul. 22, 2023 the entire contents of which is incorporated by reference herein for all purposes.

### TECHNICAL FIELD OF THE DISCLOSURE

The present disclosure relates, in general, to steering systems for use on land vehicles and, in particular, to steering systems for use on snowmobiles that include a steering column and an electronic steering assist unit that share a common axis of rotation that is positioned along the centerline of the snowmobile.

### BACKGROUND

Snowmobiles are popular land vehicles used for transportation and recreation in cold and snowy conditions. Certain snowmobiles are designed for specific applications such as trail, utility, mountain, race and crossover, to name a few. Snowmobiles typically include a chassis that supports various components of the snowmobile such as an engine, a continuously variable transmission and a ground-engaging endless drive track disposed in a longitudinally extending tunnel. The engine and transmission power the drive track to enable ground propulsion for the vehicle. A rider controls the operation of the snowmobile using a steering system that typically includes a handlebar assembly, a steering column, a steering arm assembly, a pair of tie rods and a pair ski assemblies that provide flotation for the front of the snowmobile over the snow. Some snowmobiles utilize an articulated steering column in which multiple posts are routed around other snowmobile components using joints that allow for changes in direction. Other snowmobiles utilize a straight steering column that is routed not only downwardly and forwardly from the handlebar assembly but also laterally from the handlebar assembly to avoid other snowmobile components. Both the articulated steering columns and the laterally offset steering columns require additional linkages to return the steering system to the center of the snowmobile for proper operation of the tie rods and the ski assemblies. It has been found, however, that such steering systems for snowmobiles are overly complex and add unnecessary weight to the snowmobile. Accordingly, a need has arisen for improved steering systems for snowmobiles that overcome these and other drawbacks associated with the current steering systems.

### SUMMARY

In a first aspect, the present disclosure is directed to a steering system for a snowmobile. The steering system includes a handlebar assembly and a steering column that has upper and lower ends. The upper end of the steering column is coupled to the handlebar assembly. The lower end of the steering column is coupled to an input shaft of an electronic steering assist unit. A steering arm assembly is coupled directly to an output shaft of the electronic steering assist unit. A first tie rod has proximal and distal ends wherein, the proximal end is coupled to the steering arm assembly and the distal end is coupled to a first ski assembly. A second tie rod has proximal and distal ends wherein, the proximal end is coupled to the steering arm assembly and the distal end is coupled to a second ski assembly. The steering column and the electronic steering assist unit share a common axis of rotation that is positioned along a centerline of the snowmobile.

In some embodiments, the steering column may be a straight steering column formed as a non-segmented single post. In certain embodiments, the input shaft of the electronic steering assist unit may have input splines and the lower end of the steering column may be coupled to the input splines of the electronic steering assist unit. In some embodiments, the output shaft of the electronic steering assist unit may have output splines and the steering arm assembly may be coupled directly to the output splines of the electronic steering assist unit. In certain embodiments, the snowmobile may include a forward frame assembly and the electronic steering assist unit may be coupled to the forward frame assembly. In such embodiments, the forward frame assembly may include an upper cross member and the steering column may be positioned forward of the upper cross member. Also, in such embodiments, the forward frame assembly may include a nose frame assembly that defines an electronic steering assist unit bay and the electronic steering assist unit may be positioned within the electronic steering assist unit bay. In addition, the electronic steering assist unit may be coupled to the nose frame assembly.

In some embodiments, the snowmobile may include a heat exchanger and the electronic steering assist unit may be positioned below of the heat exchanger. In certain embodiments, the snowmobile may include an engine and the electronic steering assist unit may be positioned forward of the engine. In some embodiments, the snowmobile may include an engine and a heat exchanger. In such embodiments, the heat exchanger and the electronic steering assist unit may be positioned forward of the engine and the electronic steering assist unit may be positioned below of the heat exchanger. In certain embodiments, the snowmobile may include a forward frame assembly and an engine. In such embodiments, the forward frame assembly may include a lower cross member that is positioned between the engine and the electronic steering assist unit with the engine and the electronic steering assist unit coupled to the lower cross member. For example, the engine may be coupled to the lower cross member via first and second engine mounts and the electronic steering assist unit may be coupled to the lower cross member via a mounting bracket that is positioned between the first and second engine mounts. In some embodiments, the forward frame assembly may include a nose frame assembly and a lower cross member. In such embodiments, the electronic steering assist unit may be coupled between the nose frame assembly and the lower cross member.

In a second aspect, the present disclosure is directed to a snowmobile having a chassis that includes a forward frame assembly. An engine is coupled to the forward frame assembly. A steering system of the snowmobile includes a handlebar assembly and a steering column that has upper and lower ends. The upper end of the steering column is coupled to the handlebar assembly. The lower end of the steering column is coupled to an input shaft of an electronic steering assist unit. A steering arm assembly is coupled directly to an output shaft of the electronic steering assist unit. A first tie rod has proximal and distal ends wherein, the proximal end is coupled to the steering arm assembly and the distal end is coupled to a first ski assembly. A second tie rod has proximal and distal ends wherein, the proximal end is coupled to the steering arm assembly and the distal end is coupled to a second ski assembly. The steering column and the electronic steering assist unit share a common axis of rotation that is positioned along a centerline of the snowmobile.

In certain embodiments, the engine may be an aftwardly tilted four-stroke engine. In some embodiments, the forward frame assembly may include a lower cross member that is positioned between the engine and the electronic steering assist unit. In such embodiments, the engine may be coupled to the lower cross member via first and second engine mount and the electronic steering assist unit may be coupled to the lower cross member via a mounting bracket that is positioned between the first and second engine mounts. In certain embodiments, the forward frame assembly may include a nose frame assembly that defines an electronic steering assist unit bay, the electronic steering assist unit may be positioned within the electronic steering assist unit bay and coupled to the nose frame assembly. In some embodiments, a heat exchanger may be coupled to the forward frame assembly such that the heat exchanger and the electronic steering assist unit are positioned forward of the engine and the electronic steering assist unit is positioned below of the heat exchanger.

In a third aspect, the present disclosure is directed to a snowmobile including a forward frame assembly with an engine coupled thereto. A steering column has upper and lower ends with the upper end of the steering column coupled to a handlebar assembly. The steering column is positioned along a centerline of the snowmobile. An electronic steering assist unit is coupled to a lower end of the steering column. A steering arm assembly is coupled to a lower end of the electronic steering assist unit.

In certain embodiments, the engine may be an aftwardly tilted four-stroke engine that includes one or more air intake inlets positioned on an aftward side of the engine and one or more exhaust outlets positioned on a forward side of the engine. In some embodiments, a heat exchanger may be positioned above the electronic steering assist unit. In such embodiments, at least a portion of the electronic steering assist unit may be positioned forward of the heat exchanger.

In a fourth aspect, the present disclosure is directed to a snowmobile including a forward frame assembly defining an engine bay and an electronic steering assist unit bay positioned forward of the engine bay. An engine is positioned in the engine bay. A tunnel is coupled to the forward frame assembly and positioned aft of the engine bay. A steering system includes a handlebar assembly, a steering column and a steering arm assembly. The steering column has a first end coupled to the handlebar assembly and a second end extending forward and downward from the first end. An electronic steering assist unit is at least partially positioned in the electronic steering assist unit bay. The electronic steering assist unit includes an input shaft coupled to the second end of the steering column and an output shaft coupled to the steering arm assembly. A heat exchanger is positioned above the electronic steering assist unit bay and forward of the engine bay.

In certain embodiments, the forward frame assembly may include a nose frame assembly that at least partial defines the electronic steering assist unit bay and a cross member positioned between the engine bay and the electronic steering assist unit bay. In such embodiments, the engine and the electronic steering assist unit may each be coupled to the cross member. In some embodiments, the nose frame assembly may include forward upper A-arm mounts and aft upper A-arm mounts. In such embodiments, the heat exchanger and at least a portion of the electronic steering assist unit may be positioned between the forward upper A-arm mounts and the aft upper A-arm mounts. In certain embodiments, the electronic steering assist unit may include a motor that is positioned at a forward end of the nose frame assembly. In such embodiments, the motor may at least partially extend above the electronic steering assist unit bay and forward of the heat exchanger. In some embodiments, the steering column may extend along a centerline of the vehicle and the electronic steering assist unit may be positioned along the centerline of the vehicle.

### BRIEF DESCRIPTION OF THE DRAWINGS

For a more complete understanding of the features and advantages of the present disclosure, reference is now made to the detailed description along with the accompanying figures in which corresponding numerals in the different figures refer to corresponding parts and in which:

FIGS. 1A-1E are schematic illustrations of a snowmobile having a steering system including an electronic steering assist unit positioned along the centerline of the snowmobile in accordance with embodiments of the present disclosure;

FIGS. 2A-2B are an isometric view of a forward portion of a snowmobile in accordance with embodiments of the present disclosure;

FIGS. 3A-3E are selected views of a steering system for a snowmobile including an electronic steering assist unit in accordance with embodiments of the present disclosure;

FIGS. 4A-4G are selected views of a steering system for a snowmobile including an electronic steering assist unit in accordance with embodiments of the present disclosure; and

FIGS. 5A-5F are selected views of a steering system for a snowmobile including an electronic steering assist unit in accordance with embodiments of the present disclosure.

### DETAILED DESCRIPTION

While the making and using of various embodiments of the present disclosure are discussed in detail below, it should be appreciated that the present disclosure provides many applicable inventive concepts, which can be embodied in a wide variety of specific contexts. The specific embodiments discussed herein are merely illustrative and do not delimit the scope of the present disclosure. In the interest of clarity, all features of an actual implementation may not be described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present disclosure, the devices, members, apparatuses, and the like described herein may be positioned in any desired orientation. Thus, the use of terms such as “above,” “below,” “upper,” “lower” or other like terms to describe a spatial relationship between various components or to describe the spatial orientation of aspects of such components should be understood to describe a relative relationship between the components or a spatial orientation of aspects of such components, respectively, as the devices described herein may be oriented in any desired direction. As used herein, the term “coupled” may include direct or indirect coupling by any means, including by mere contact or by moving and/or non-moving mechanical connections.

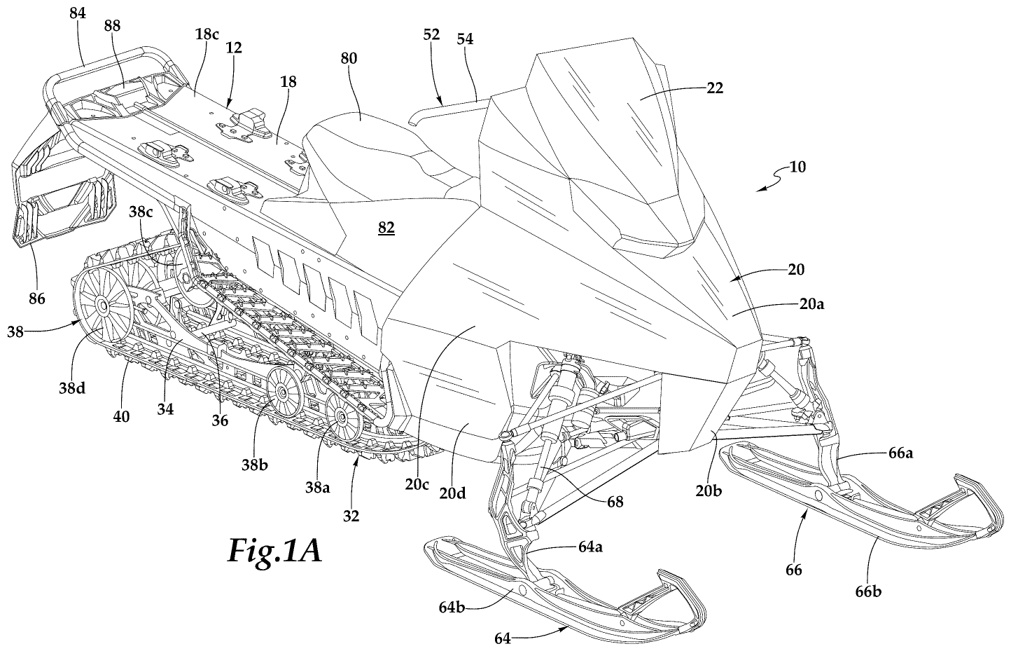

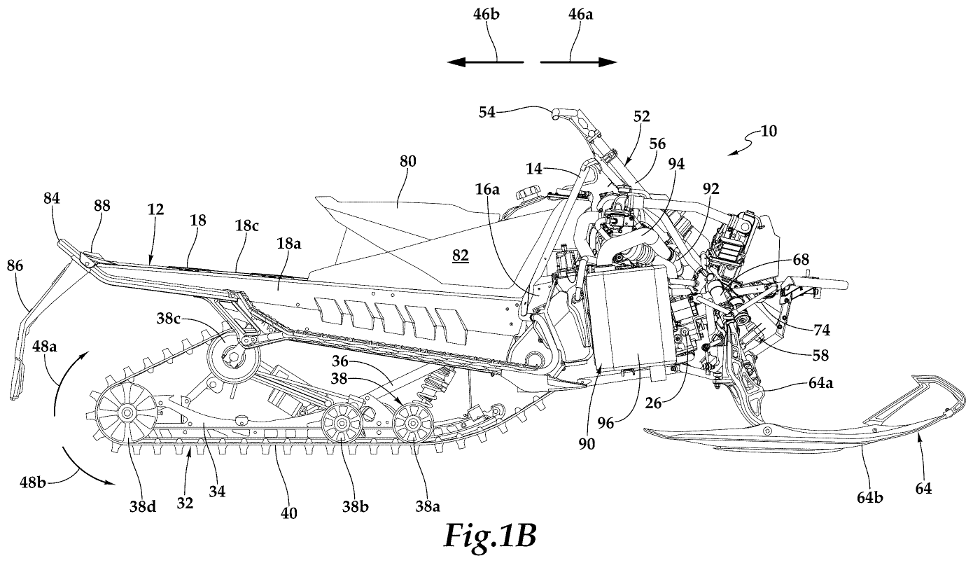

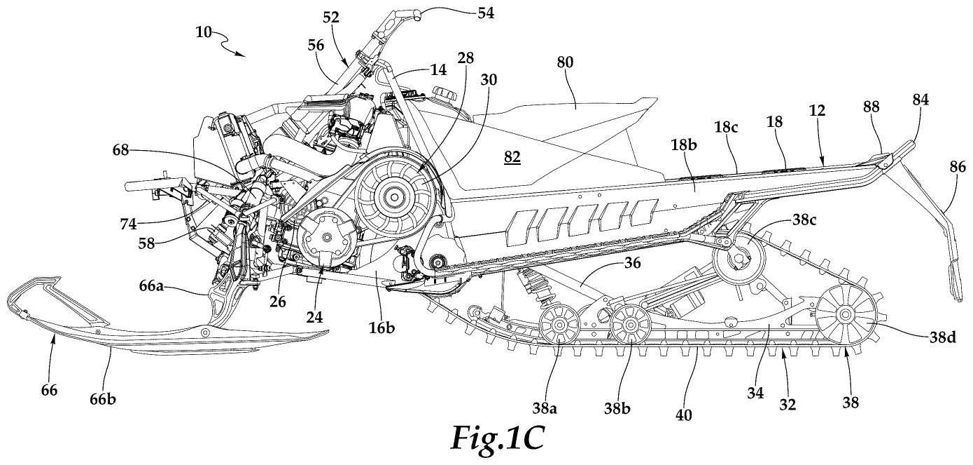

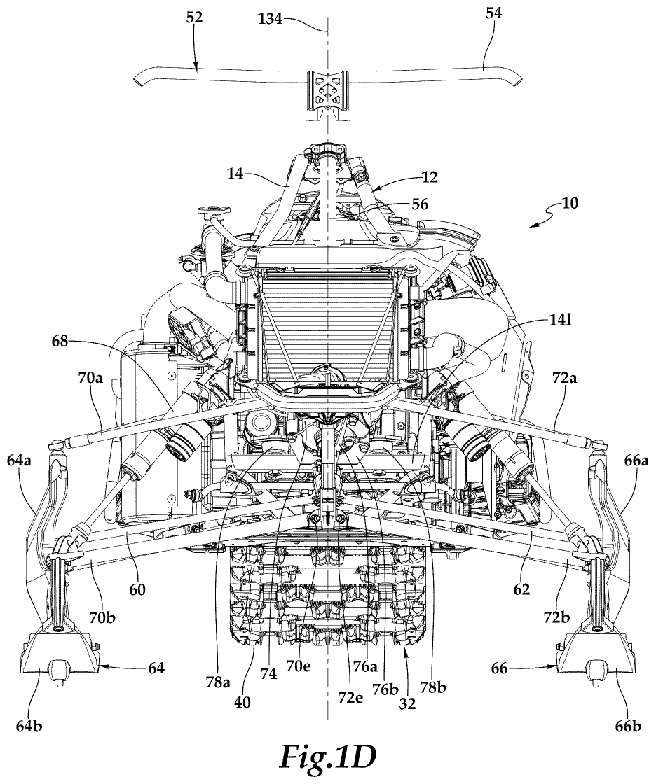

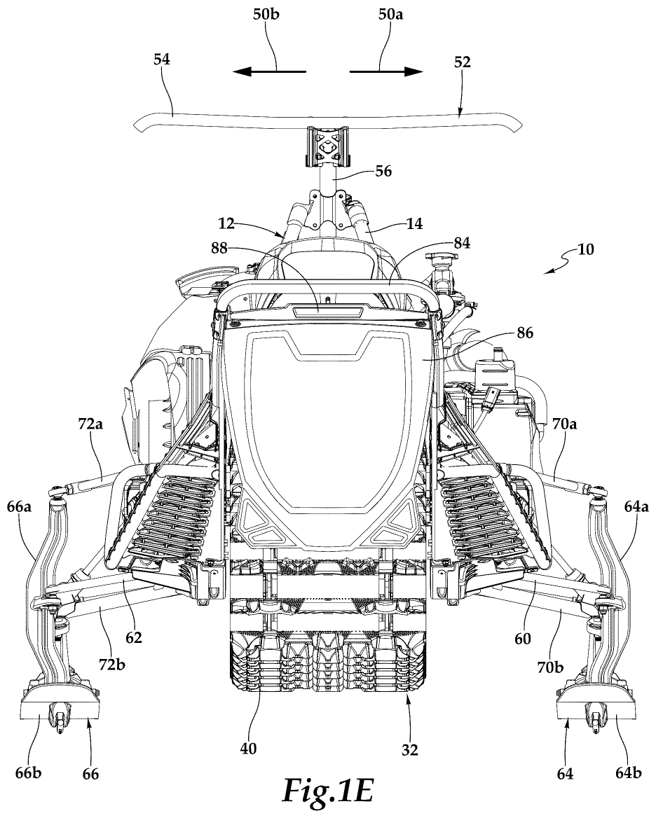

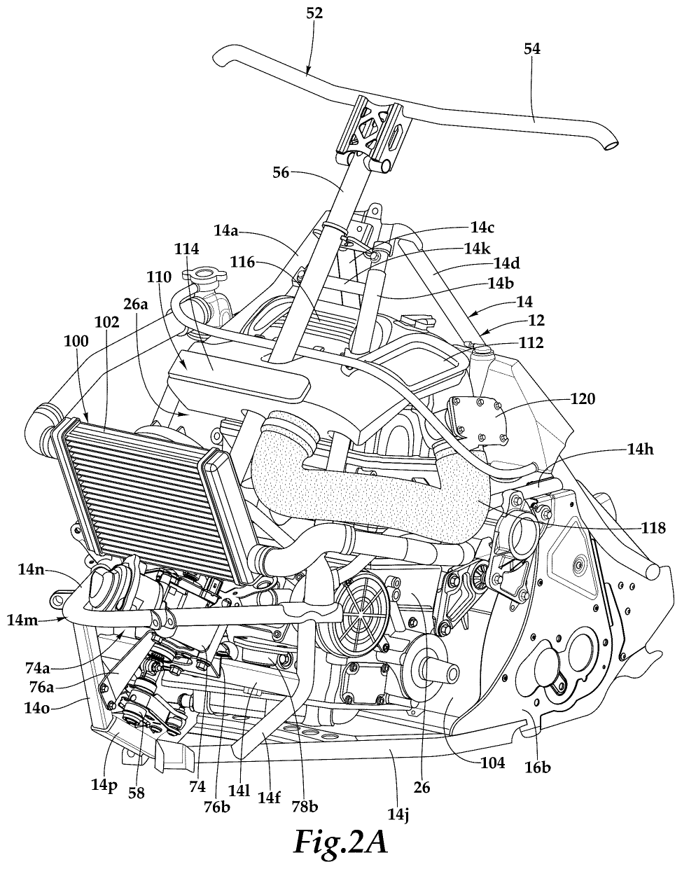

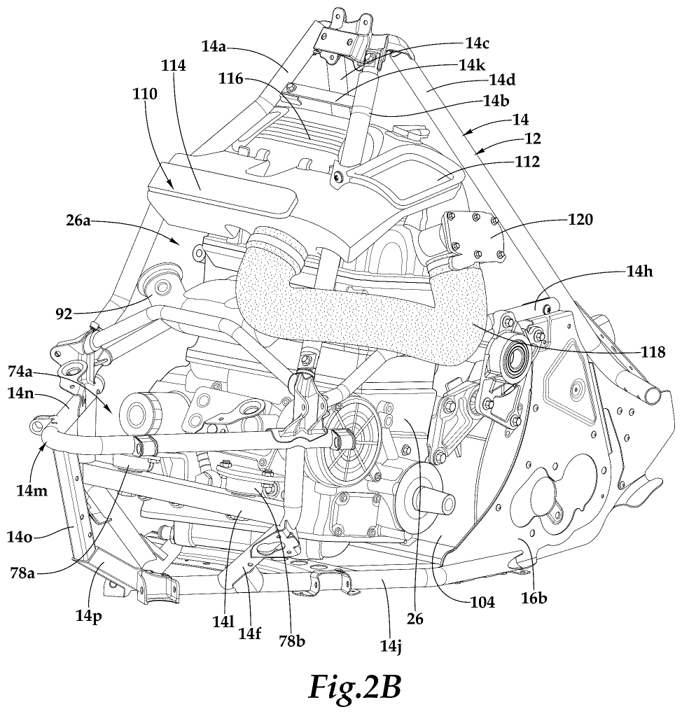

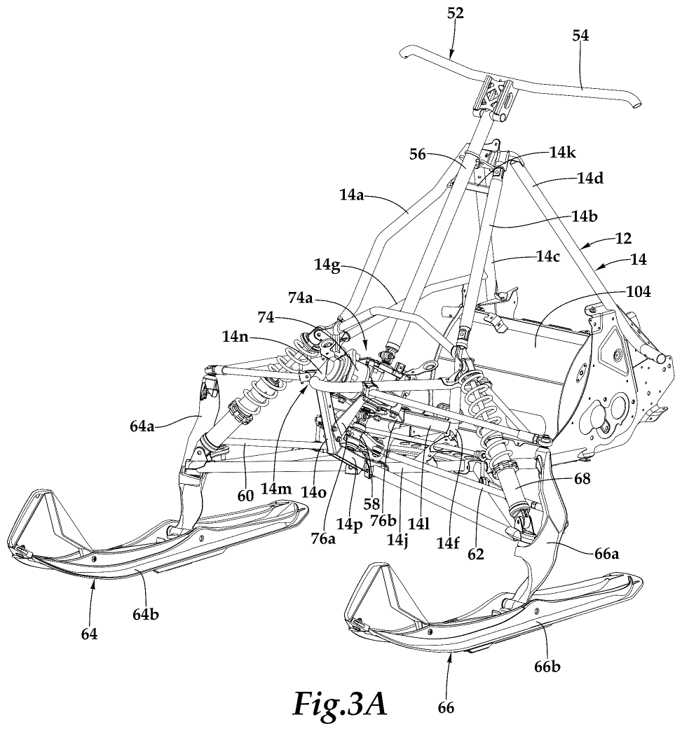

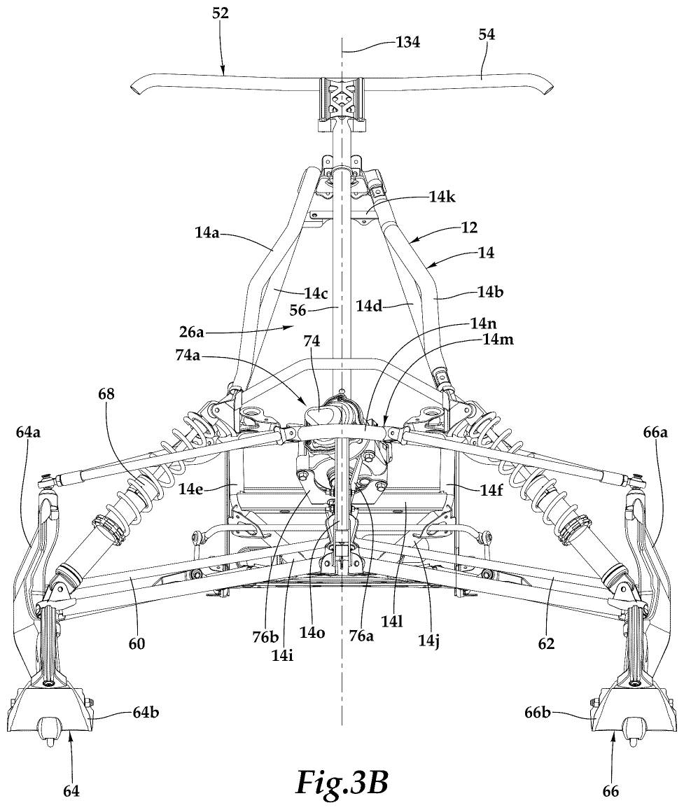

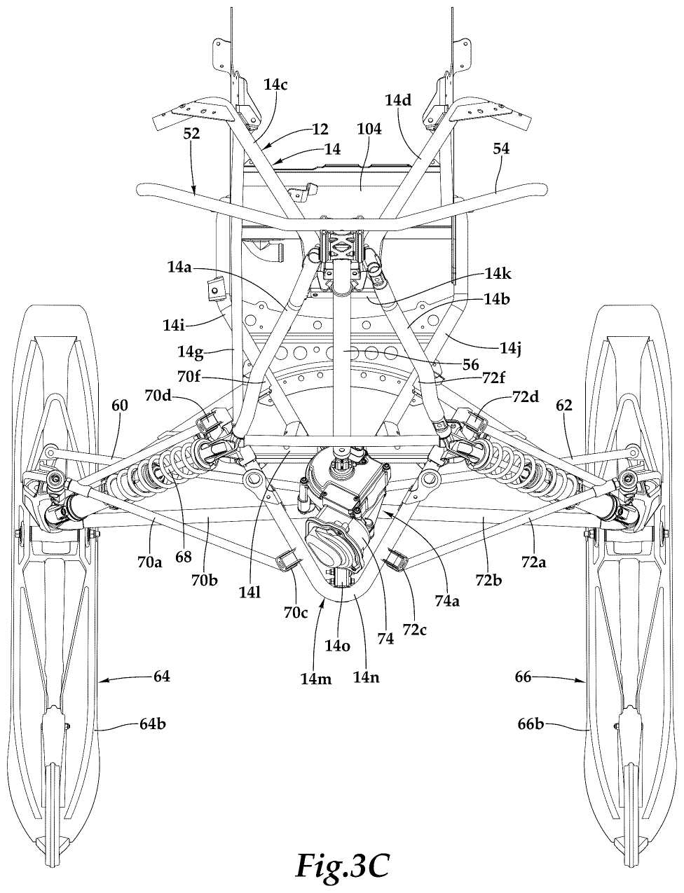

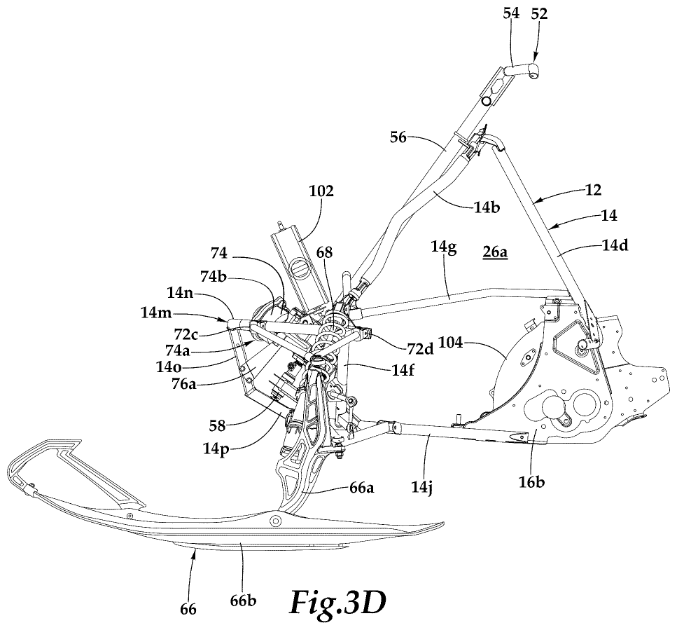

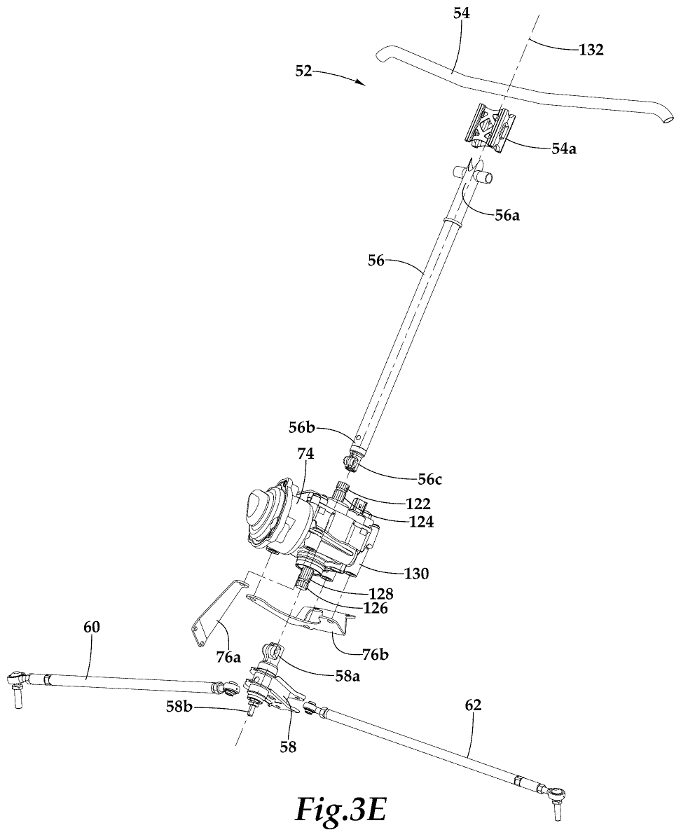

Referring to FIGS. 1A-1E in the drawings, a land vehicle depicted as a snowmobile is schematically illustrated and generally designated 10. Structural support for snowmobile 10 is provided by a chassis 12 that includes a forward frame assembly 14 a longitudinally extending tunnel 18. Forward frame assembly 14 (see also FIGS. 2 and 3A-3D) may be formed from interconnected tubular members such as round and hollow tubular members comprised of metal, metal alloy, polymeric materials, fiber reinforced polymer composites and/or combinations thereof that are coupled together by welds, bolts, pins or other suitable fastening means. In the illustrated embodiment, forward frame assembly 14 includes a right-forward spar 14a, a left-forward spar 14b, a right-aft spar 14c, a left-aft spar 14d, a right truss 14e, a left truss 14f, a right-upper beam 14g, a left-upper beam 14h, a right-lower beam 14i, a left-lower beam 14j, an upper cross member 14k, a lower cross member 14l and a nose frame assembly 14m including a nose rail 14n and a nose truss 14o. Forward frame assembly also includes a pivot mount joint 14p that couples to and is preferably welded to right-lower beam 14i, left-lower beam 14j and nose truss 14o. Pivot mount joint 14p may be of the type disclosed in commonly-owned U.S. patent application Ser. No. 18/103,879, the entire contents of which is incorporated by reference herein for all purposes. A right side plate member 16a and a left side plate member 16b are coupled to and preferably welded to forward frame assembly 14 such that forward frame assembly 14 and plate members 16a, 16b form a welded frame assembly. Tunnel 18 is coupled to forward frame assembly 14 and/or plate members 16a, 16b with welds, bolts, rivets or other suitable means. In the illustrated embodiment, tunnel 18 includes a right side panel 18a, a left side panel 18b and a top panel 18c. Tunnel 18 may be integrally formed or may consist of multiple members that are coupled together with welds, bolts, rivets or other suitable means. Plate members 16a, 16b and tunnel 18 may be formed from sheet metal, metal alloy, fiber reinforced polymer or other suitable material or combination of materials.

Various components of snowmobile 10 are assembled on or around forward frame assembly 14. One or more body panels 20 cover and protect the various components of snowmobile 10 including parts of forward frame assembly 14. For example, a hood panel 20a, a nose panel 20b, an upper right side panel 20c and a lower right side panel 20d shield underlying componentry from the snow and terrain. Similarly, an upper left side panel and a lower left side panel (not visible) also shield underlying componentry from the snow and terrain. In the illustrated embodiment, snowmobile 10 has a windshield 22 that shields the rider of snowmobile 10 from snow, terrain and frigid air during operation. Even through snowmobile 10 has been described and depicted as including specific body panels 20, it should be understood by those having ordinary skill in the art that a snowmobile of the present disclosure may include any number of body panels in any configuration to provide the shielding functionality. In addition, it should be understood by those having ordinary skill in the art that the right side and the left side of snowmobile 10 will be with reference to a rider of snowmobile 10 with the right side of snowmobile 10 corresponding to the right side of the rider and the left side of snowmobile 10 corresponding to the left side of the rider.

Body panels 20 have been removed from snowmobile 10 in FIGS. 1B-1E to reveal the underlying components of snowmobile 10. For example, snowmobile 10 has a powertrain 24 that includes an engine 26 and a drivetrain 28 both of which are coupled to forward frame assembly 14. Engine 26 resides in an engine bay 26a formed within forward frame assembly 14. In the illustrated embodiment, engine bay 26a is defined by right-forward spar 14a, left-forward spar 14b, right-aft spar 14c, left-aft spar 14d, right truss 14e, left truss 14f, right-upper beam 14g, left-upper beam 14h, right-lower beam 14i, left-lower beam 14j and lower cross member 14l. In this position, tunnel 18 is positioned aft of engine bay 26a. In the illustrated embodiment, engine 26 is a four-stroke, three cylinder engine that is aftwardly tilted and has air intake inlets on the aftward side of engine 26 and exhaust outlets on the forward side of engine 26. In other embodiments, an engine of the present disclosure may be a two-stroke engine, an electric motor, a hybrid engine or other prime mover. In addition, an engine of the present disclosure may have more than or less than three cylinders, may be vertically mounted or mounted with a forward tilt and/or may have air intake inlets or exhaust outlets in other locations. In the illustrated embodiment, engine 26 is an internal combustion engine such as a naturally aspirated internal combustion engine or a forced induction internal combustion engine that includes, for example, one or more turbochargers and/or superchargers. Drivetrain 28 includes a transmission 30 such as a continuously variable transmission, an electrically variable transmission or other suitable transmission type for varying the ratio of the engine output speed to the drive track input speed.

A drive track system 32 is at least partially disposed within and/or below tunnel 18 and is in contact with the ground to provide ground propulsion for snowmobile 10. Torque and rotational energy are provided to drive track system 32 from engine 26 via drivetrain 28. Drive track system 32 includes a track frame 34, an internal suspension 36, a plurality of idler wheels 38 such as idler wheels 38a, 38b, 38c, 38d and an endless track 40. Track frame 34 may be coupled to forward frame assembly 14 via a swing arm having a coil spring, a rigid strut, a torsion spring, an elastomeric member or any other suitable coupling configuration. Endless track 40 is driven by a track drive sprocket via a track driveshaft (not visible) that is rotated responsive to torque provided from powertrain 24. Endless track 40 rotates around track frame 34 and idler wheels 38 to propel snowmobile 10 in either the forward direction, as indicated by arrow 46a, or the backwards direction, as indicated by arrow 46b in FIG. 1B. When viewed from the right side of snowmobile 10, endless track 40 rotates around track frame 34 and idler wheels 38 in the clockwise direction, as indicated by arrow 48a, to propel snowmobile 10 in the forward direction 46a. Endless track 40 rotates around track frame 34 and idler wheels 38 in the counterclockwise direction, as indicated by arrow 48b, to propel snowmobile 10 in the backward direction 46b. The forward and backward directions also represent the longitudinal direction of snowmobile 10 with the lateral direction of snowmobile 10 being normal thereto and represented by the rightward direction, as indicated by arrow 50a, and the leftward direction, as indicated by arrow 50b in FIG. 1E. The backward direction may also be referred to herein as the aftward direction.

Snowmobile 10 has a steering system 52 that includes a handlebar assembly 54, a steering column 56, a steering arm assembly 58, a right tie rod 60, a left tie rod 62, a right ski assembly 64 including a right spindle 64a and a right ski 64b, and left ski assembly 66 including a left spindle 66a and a left ski 66b. Snowmobile 10 has a front suspension assembly 68 that is coupled between forward frame assembly 14 and ski assemblies 64, 66 to provide front end support for snowmobile 10. An upper A-arm 70a couples right ski assembly 64 to nose rail 14n of forward frame assembly 14 at upper A-arm mounts 70c, 70d (see also FIG. 3C). In addition, a lower A-arm 70b couples right ski assembly 64 to forward frame assembly 14 at lower A-arm mounts 70e, 70f. An upper A-arm 72a couples left ski assembly 66 to nose rail 14n of forward frame assembly 14 at upper A-arm mounts 72c, 72d (see also FIG. 3C). In addition, a lower A-arm 72b couples left ski assembly 66 to forward frame assembly 14 at lower A-arm mounts 72e, 72f. Upper A-arm mounts 70c, 72c may collectively be referred to herein as forward upper A-arm mounts 70c, 72c. Upper A-arm mounts 70d, 72d may collectively be referred to herein as aft upper A-arm mounts 70d, 72d. Lower A-arm mounts 70e, 72e may collectively be referred to herein as forward lower A-arm mounts 70e, 72e. Lower A-arm mounts 70f, 72f may collectively be referred to herein as aft lower A-arm mounts 70f, 72f.

Steering system 52 enables the rider to steer snowmobile 10 by rotating handlebar assembly 54 which causes ski assemblies 64, 66 to pivot. In the illustrated embodiment, the pivoting of ski assemblies 64, 66 responsive to rotation of handlebar assembly 54 is assisted by an electric power steering system (EPS) depicted as electronic steering assist unit 74. As best seen in FIG. 2, electronic steering assist unit 74 is at least partially positioned within an electronic steering assist unit bay 74a that is defined by right truss 14e, left truss 14f, a forward portion of right-lower beam 14i, a forward portion of left-lower beam 14j, lower cross member 14l, nose rail 14n, nose truss 14o and pivot mount joint 14p. As lower cross member 14l helps to define both engine by 26a and electronic steering assist unit bay 74a, lower cross member 14l is considered to be positioned between engine bay 26a and electronic steering assist unit bay 74a. In this location, at least a portion of electronic steering assist unit 74 is positioned between forward upper A-arm mounts 70c, 72c and aft upper A-arm mounts 70d, 72d of nose rail 14n. Also, as best seen in FIG. 3C, radiator 102 is positioned between forward upper A-arm mounts 70c, 72c and aft upper A-arm mounts 70d, 72d of nose rail 14n. Electronic steering assist unit 74 is coupled to forward frame assembly 14 via a nose bracket 76a that is coupled between electronic steering assist unit 74 and nose truss 140 and an aft bracket 76b that is coupled between electronic steering assist unit 74 and lower cross member 141. As best seen in FIGS. 1D and 2, lower cross member 141 is positioned between electronic steering assist unit 74 and engine 26. In this position, lower cross member 141 resiliently supports engine 26 via right-front engine mount 78a and left-front engine mount 78b. Aft bracket 76b for electronic steering assist unit 74 is coupled to lower cross member 14l between right-front engine mount 78a and left-front engine mount 78b. Nose bracket 76a provides primary support for electronic steering assist unit 74 while aft bracket 76b prevents relative rotation between electronic steering assist unit 74 and forward frame assembly 14. As best seen in FIG. 3C, electronic steering assist unit 74 includes a motor 74b that is positioned at a forward portion of nose frame assembly 14m. In this location, motor 74b at least partially extends above electronic steering assist unit bay 74a and forward of radiator 102.

The rider controls snowmobile 10 from a seat 80 that is position atop a fuel tank 82, above tunnel 18, aft of handlebar assembly 54 and aft of forward frame assembly 14. Snowmobile 10 has a lift bumper 84 that is coupled to an aft end of tunnel 18 that enables a person to lift the rear end of snowmobile 10 in the event snowmobile 10 becomes stuck or needs to be repositioned when it is not moving. Snowmobile 10 has a snow flap 86 that deflects snow emitted by endless track 40. In the illustrated embodiment, snow flap 86 is coupled to lift bumper 84. In other embodiments, a snow flap may be coupled directly to tunnel 18. A taillight housing 88 is also coupled to lift bumper 84 and houses a taillight of snowmobile 10. Snowmobile 10 has an exhaust system 90 that includes an exhaust manifold 92 that is coupled to one or more exhaust outlets on the forward side of engine 26, an exhaust duct 94 and a muffler 96. Exhaust system 90 is configured to direct high-temperature exhaust gases away from engine 26 and the rider of snowmobile 10. As exhaust system 90 including exhaust manifold 92 is coupled to the forward side of engine 26, the forward side of engine 26 may be referred to herein as the hot side of engine 26 due to the hot temperatures associated with engine exhaust. The aftward side of engine 26 is concomitantly considered the cool side of engine 26 as hot exhaust system components are located opposite and/or remote therefrom.

It should be appreciated that snowmobile 10 is merely illustrative of a variety of vehicles that can implement the embodiments disclosed herein. Other vehicle implementations can include motorcycles, snow bikes, all-terrain vehicles (ATVs), utility vehicles, recreational vehicles, scooters, automobiles, mopeds, straddle-type vehicles and the like. As such, those skilled in the art will recognize that the embodiments disclosed herein can be integrated into a variety of vehicle configurations. It should be appreciated that even though ground-based vehicles are particularly well-suited to implement the embodiments of the present disclosure, airborne vehicles and devices such as aircraft can also implement the embodiments.

Referring additionally to FIG. 2 of the drawings, further details of snowmobile 10 will now be discussed. In the illustrated embodiments, engine 26 is an aftwardly tilted engine such that an upper portion of engine 26 is aft of a lower portion of engine 26. For example, engine 26 is aftwardly tilted between five degrees and twenty degrees from vertical such as about ten degrees from vertical. It should be understood by those having ordinary skill in the art that engine 26 could have other aftwardly tilted angles both less than five degrees and greater than twenty degrees from vertical. In the illustrated embodiment, a cooling system 100 includes a forward heat exchanger 102, depicted as a radiator 102, and an arcuate heat exchanger 104. In other embodiments, a cooling system for a snowmobile may not include a forward heat exchanger, the forward heat exchanger may be an intercooler or the forward heat exchanger may include both a radiator and an intercooler. In the illustrated embodiment, radiator 102 is coupled to forward frame assembly 14 and more specifically, radiator 102 is coupled to and positioned about a centerline 134 of snowmobile 10 above electronic steering assist unit bay 74a and forward of engine bay 26a. Radiator 102 is tilted forward such that an upper portion of radiator 102 is forward of a lower portion of radiator 102. Radiator 102 is configured to remove heat from a fluid circulating therethrough responsive to air passing through radiator 102 from the front side of radiator 102 to the rear side of radiator 102 and then into engine bay 26a. Arcuate heat exchanger 104 is coupled to a forward portion of tunnel 18 and to forward frame assembly 14. In this location, arcuate heat exchanger 104 is positioned aft of engine 26 and below fuel tank 82. Arcuate heat exchanger 104 is configured to remove heat from a fluid circulating therethrough responsive to snow in tunnel 18. For example, during operation of snowmobile 10, endless track 40 kicks snow toward an inner surface of arcuate heat exchanger 104 which is configured to retain at least a portion of this snow. Heat from the fluid circulating through arcuate heat exchanger 104 is transferred to the retained snow causing the retained snow to melt. As discussed herein, electronic steering assist unit 74 is at least partially positioned within electronic steering assist unit bay 74a with nose bracket 76a coupled between electronic steering assist unit 74 and nose truss 140 and with aft bracket 76b coupled between electronic steering assist unit 74 and lower cross member 141. In this position, electronic steering assist unit 74 is positioned forward of engine 26 and below radiator 102 with at least a portion of electronic steering assist unit 74 forward of radiator 102.

In the illustrated embodiment, engine 26 has an air intake system 110 that receives air from the atmosphere and distributes the air to each of the cylinders of engine 26. More specifically, air intake system 110 includes an air inlet 112 that feeds air into an airbox 114 that is positioned generally forward and generally above engine 26. Air from airbox 114 is routed to an air intake plenum 116 positioned above engine 26 via an air duct 118. The volume of air delivered to air intake plenum 116 from airbox 114 is controlled via a throttle body valve assembly 120. Air intake plenum 116 is configured to dampen the air flow prior to distribution of the air to the cylinders of engine 26 via air intake runners that extend downwardly and aftwardly from air intake plenum 116 and couple to one or more air inlets positioned on the aftward side of engine 26.

Referring additionally to FIGS. 3A-3E of the drawings, further details relating to steering system 52 of snowmobile 10 will now be disclosed. As discussed herein, steering system 52 includes handlebar assembly 54, steering column 56, steering arm assembly 58, right tie rod 60, left tie rod 62, right ski assembly 64 including right spindle 64a and right ski 64b, and left ski assembly 66 including left spindle 66a and left ski 66b. In addition, steering system 52 includes electronic steering assist unit 74. Steering column 56 is a straight steering column formed as a non-segmented single post that is positioned forward of upper cross member 14k. As best seen in FIG. 3E, steering column 56 has an upper end 56a and lower end 56b that extends is forward and downward from upper end 56a. Upper end 56a of steering column 56 is coupled to handlebar assembly 54 via a handlebar bracket 54a. Lower end 56b of steering column 56 includes a splined coupler 56c that may be integral with or coupled to lower end 56b of steering column 56. Splined coupler 56c receives an input shaft 122 having input splines 124 therein to couple lower end 56b of steering column 56 to electronic steering assist unit 74. Steering arm assembly 58 includes a splined coupler 58a that receives an output shaft 126 having output splines 128 therein such that electronic steering assist unit 74 is coupled directly to steering arm assembly 58 without a steering column post or other extension positioned therebetween. Steering arm assembly 58 is coupled to the proximal ends tie rods 60, 62. The distal ends of tie rods 60, 62 are respectively coupled to ski assemblies 64, 66 such that rotation of handlebar assembly 54 by the rider of snowmobile 10, together with the assist of electronic steering assist unit 74, causes ski assemblies 64, 66 to pivot, thus turning snowmobile 10. A lower end 58b of steering arm assembly 58 is received within a bearing assembly (not visible) of pivot mount joint 14p such that steering arm assembly 58 is operable to rotate relative thereto.

Electronic steering assist unit 74 includes an outer housing 130 that contains the working components thereof including, for example, an electric motor, a torque sensor, a controller and a torsion bar that couples input shaft 122 to output shaft 126. Outer housing 130 is fixed against rotation relative to forward frame assembly 14 by brackets 76a, 76b. In operation, the input torque applied from handlebar assembly 54 via steering column 56 on input shaft 122 is measured by the torque sensor. Input torque data is then provided to the controller from the torque sensor. Based upon the input torque data and additional factors such as the speed of snowmobile 10, the controller commands the electric motor to provide an output assist torque to output shaft 126 that is additive to the input torque applied to output shaft 126 from input shaft 122 via the torsion bar. The use of electronic steering assist unit 74 improves the handling of snowmobile 10, reduces fatigue associated with driving snowmobile 10 and can allow snowmobile 10 to be driven more aggressively. In addition, coupling electronic steering assist unit 74 directly to steering arm assembly 58 has numerous advantages over prior snowmobile steering systems that have electronic steering assist units including lowering the center of gravity of snowmobile 10 by positioning the electronic steering assist unit at a lowermost location of the steering column. In addition, coupling electronic steering assist unit 74 directly to steering arm assembly 58, together with using a straight steering column 56 and having a common axis of rotation 132 shared by handlebar assembly 54, steering column 56, electronic steering assist unit 74 and steering arm assembly 58 that is positioned along a centerline 134 (see FIG. 3B) of snowmobile 10, reduces the number of parts required in steering system 52 and reduces the complexity of steering system 52, which improves the overall reliability of snowmobile 10.

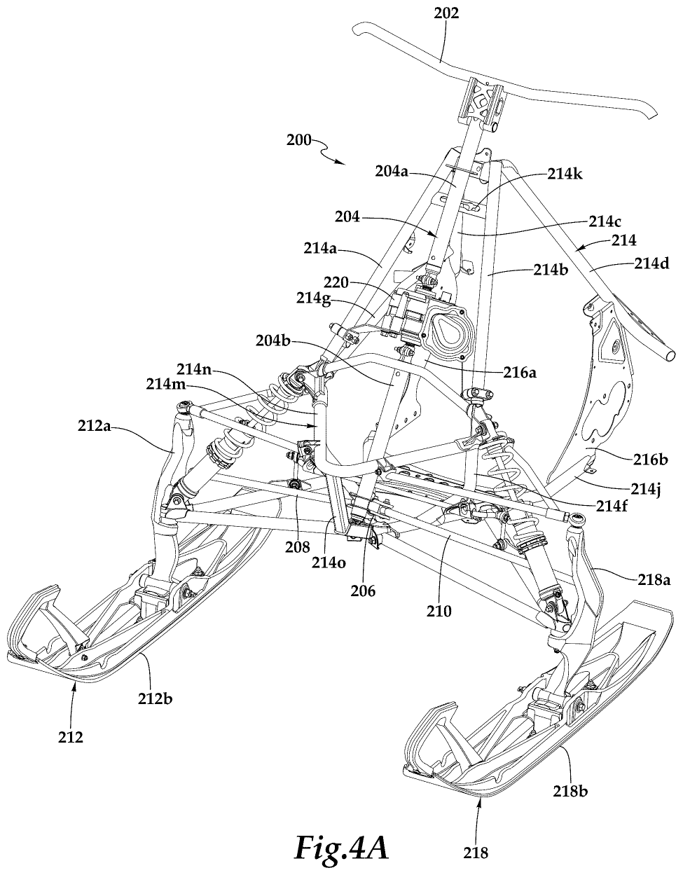

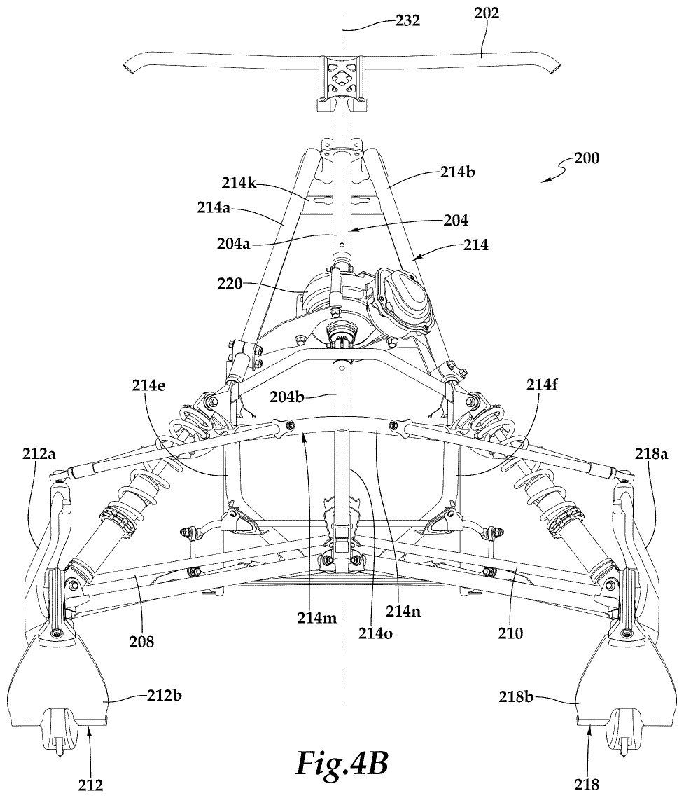

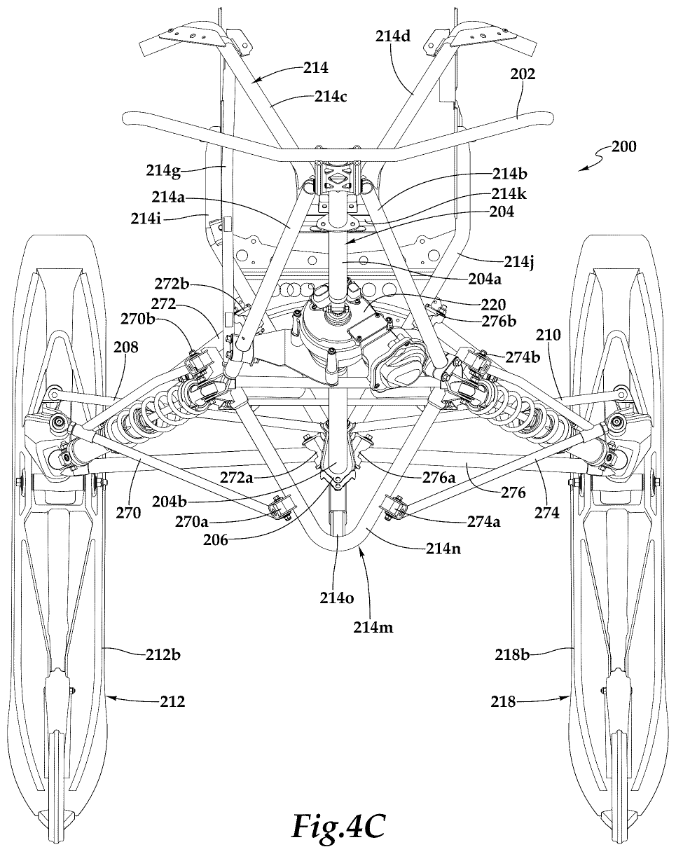

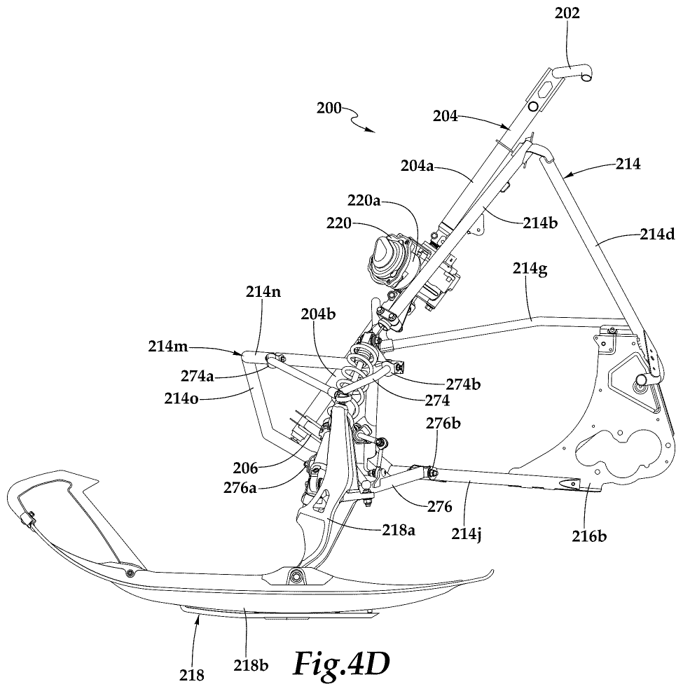

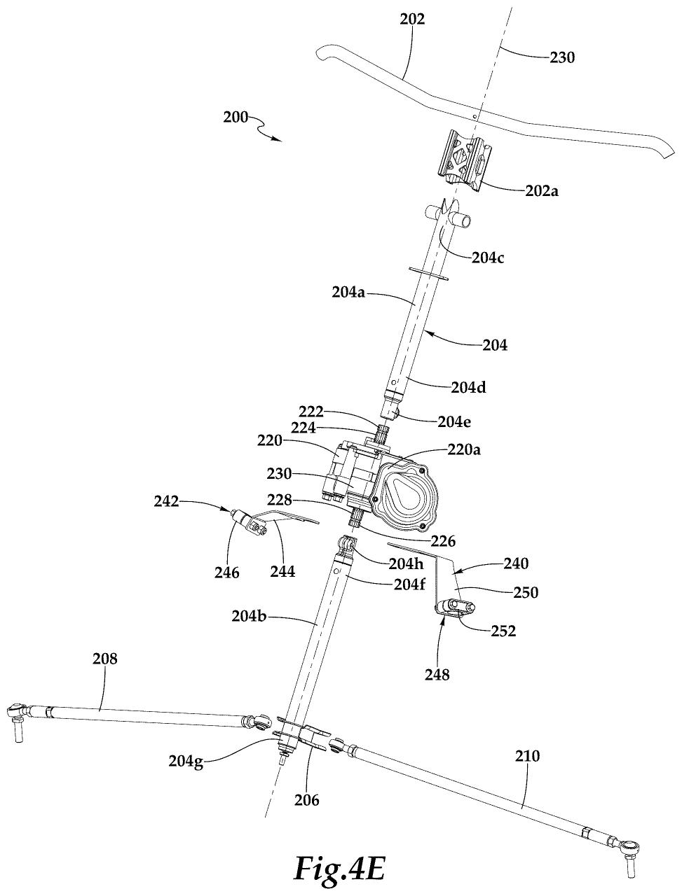

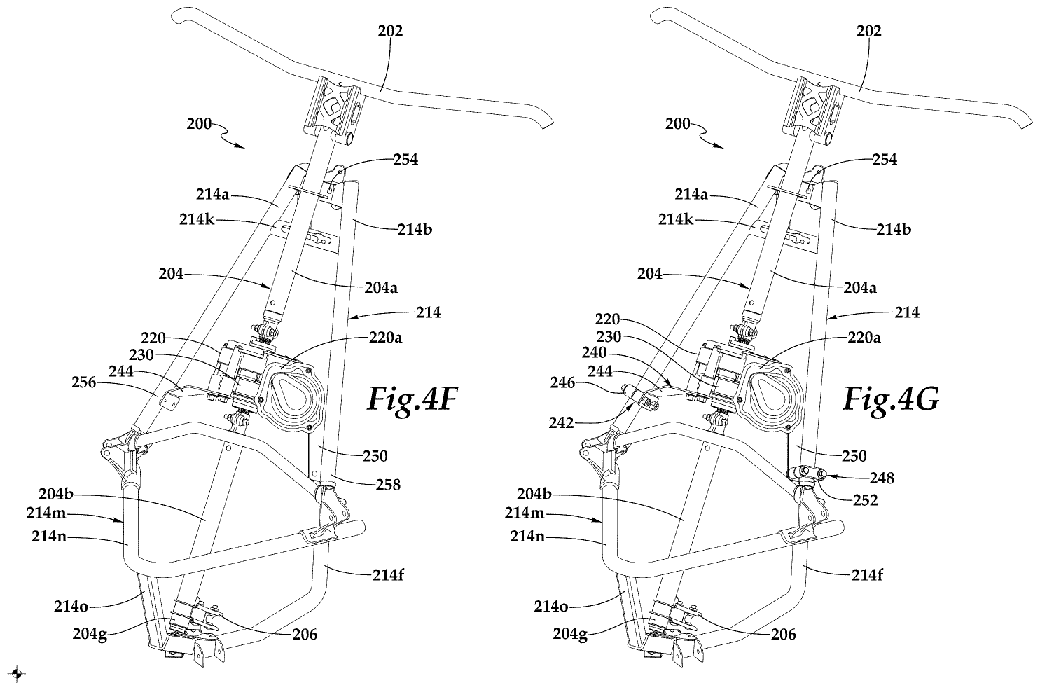

Referring now to FIGS. 4A-4G of the drawings, an embodiment of a steering system for a snowmobile, such as snowmobile 10 or a snowmobile having a two-stroke engine that is aftwardly tilted and has air intake inlets on the aftward side of the engine and exhaust outlets on the forward side of the engine, will now be discussed. Steering system 200 includes a handlebar assembly 202, a steering column 204, a steering arm assembly 206, a right tie rod 208, a left tie rod 210, a right ski assembly 212 including a right spindle 212a and a right ski 212b, and a left ski assembly 218 including a left spindle 218a and a left ski 218b. In addition, steering system 200 includes an electric power steering system depicted as an electronic steering assist unit 220. Steering system 200 is coupled to a forward frame assembly 214 that includes a right-forward spar 214a, a left-forward spar 214b, a right-aft spar 214c, a left-aft spar 214d, right truss 214e, a left truss 214f, a right-upper beam 214g, a left-upper beam (not installed in the illustrated embodiment), a right-lower beam 214i, a left-lower beam 214j, an upper cross member 214k and a nose frame assembly 214m including a nose rail 214n and a nose truss 214o. Plate members 216a, 216b are coupled to and preferably welded to forward frame assembly 214 such that forward frame assembly 214 and plate members 216a, 216b form a welded frame assembly. Right ski assembly 212 is coupled to forward frame assembly 214 by an upper A-arm 270 at forward and aftward mounting points 270a, 270b and by a lower A-arm 272 at forward and aftward mounting points 272a, 272b. Likewise, left ski assembly 218 is coupled to forward frame assembly 214 by an upper A-arm 274 at forward and aftward mounting points 274a, 274b and by a lower A-arm 276 at forward and aftward mounting points 276a, 276b.

In the illustrated embodiments, steering column 204 is a straight steering column formed from an upper post 204a that is positioned forward of upper cross member 214k and a lower post 204b. As best seen in FIG. 4E, upper post 204a of steering column 204 has an upper end 204c and lower end 204d. Upper end 204c of upper post 204a is coupled to handlebar assembly 202 via a handlebar bracket 202a. Lower end 204d of upper post 204a includes a splined coupler 204e that may be integral with or coupled to lower end 204d of upper post 204a. Splined coupler 204e receives an input shaft 222 having input splines 224 therein to couple lower end 204d of upper post 204a to electronic steering assist unit 220. Lower post 204b of steering column 204 has an upper end 204f and lower end 204g. Upper end 204f of lower post 204b includes a splined coupler 204h that may be integral with or coupled to upper end 204f of lower post 204b. Splined coupler 204h receives an output shaft 226 having output splines 228 therein to couple upper end 204f of lower post 204b to electronic steering assist unit 220. Steering arm assembly 206 is coupled to lower end 204g of lower post 204b. Steering arm assembly 206 is coupled to the proximal ends tie rods 208, 210. The distal ends of tie rods 208, 210 are respectively coupled to ski assemblies 212, 218 such that rotation of handlebar assembly 202 by the rider of the snowmobile, together with the assist of electronic steering assist unit 220, causes ski assemblies 212, 218 to pivot, thus turning the snowmobile. Lower end 204g of lower post 204b is received within a bearing assembly (not visible) of nose truss 2140 such that lower post 204b is operable to rotate relative thereto.

Electronic steering assist unit 220 includes an outer housing 230 that contains the working components thereof including, for example, an electric motor 220a, a torque sensor, a controller and a torsion bar that couples input shaft 222 to output shaft 226. In operation, the input torque applied from handlebar assembly 202 via upper post 204a on input shaft 222 is measured by the torque sensor. Input torque data is then provided to the controller from the torque sensor. Based upon the input torque data and additional factors such as the speed of the snowmobile, the controller commands electric motor 220a to provide an output assist torque to output shaft 226 that is additive to the input torque applied to output shaft 226 from input shaft 222 via the torsion bar. The use of electronic steering assist unit 220 improves the handling of the snowmobile, reduces fatigue associated with driving the snowmobile and can allow the snowmobile to be driven more aggressively. In addition, using steering system 200 that has a common axis of rotation 230 shared by handlebar assembly 202, steering column 204, electronic steering assist unit 220 and steering arm assembly 206 that is positioned along a centerline 232 (see FIG. 4B) of the snowmobile, reduces the number of parts required in steering system 200 and reduces the complexity of steering system 200, which improves the overall reliability of the snowmobile.

To prevent a torque pre-load on electronic steering assist unit 220, the present embodiment utilizes a floating mounting system 240 to couple electronic steering assist unit 220 to forward spars 214a, 214b. For example, a torque pre-load on electronic steering assist unit 220 could cause the torque sensor to sense the presence of an input torque even when no input torque is being applied from handlebar assembly 202 via upper post 204a on input shaft 222. Likewise, a torque pre-load on electronic steering assist unit 220 could cause the torque sensor to sense an inaccurate input torque applied from handlebar assembly 202 via upper post 204a on input shaft 222. In either case, the phantom presence of an input torque or a distorted input torque causes erroneous input torque data to be provided to the controller from the torque sensor. This erroneous input torque data then causes the controller to send erroneous commands to electric motor 220a causing erroneous output assist torque to be applied to output shaft 226. To prevent such a torque pre-load on electronic steering assist unit 220, the vertical position of electronic steering assist unit 220 is determined by steering column 204 and not by predetermined mounting points on either of forward spars 214a, 214b such as predrilled holes in forward spars 214a, 214b or pre-welded supports on forward spars 214a, 214b.

In the present embodiment, floating mounting system 240 is used to couple electronic steering assist unit 220 to forward spars 214a, 214b. Floating mounting system 240 includes a right floating clamp assemblies 242 that is formed from a right mounting bracket 244 and a right clamp 246, and a left floating clamp assemblies 248 that is formed from a left mounting bracket 250 and a left clamp 252 wherein, clamps 246, 252 are depicted as pillow block clamps. During installation, steering column 204, electronic steering assist unit 220 and steering arm assembly 206 are preferably preassembled then positioned along centerline 232 of the snowmobile with lower end 204g of lower post 204b received within a bearing assembly (not visible) of nose truss 2140 and upper post 204a received on a forward side of steering column mount 254, as best seen in FIG. 4F. Right mounting bracket 244 and left mounting bracket 250 may be part of the preassembly or may be bolted on to outer housing 230 of electronic steering assist unit 220 after steering column 204, electronic steering assist unit 220 and steering arm assembly 206 have been received by forward frame assembly 214. In either case, once coupled to electronic steering assist unit 220, right mounting bracket 244 aligns with a nonpredetermined location 256 of right-forward spar 214a and left mounting bracket 250 aligns with a nonpredetermined location 258 of left-forward spar 214b.

Next, right clamp 246 is used to couple right mounting bracket 244 to right-forward spar 214a at nonpredetermined location 256 and left clamp 252 is used to couple left mounting bracket 250 to left-forward spar 214b at nonpredetermined location 258, as best seen in FIG. 4G. In the clamped orientation, outer housing 230 is fixed against rotation relative to forward frame assembly 214. As nonpredetermined locations 256, 258 that clamps 246, 252 couple brackets 244, 250 to spars 214a, 214b are not constrained by predrilled holes or pre-welded supports, torque pre-load caused by misalignment of electronic steering assist unit 220 is prevented. Specifically, due to manufacturing tolerances and/or assembly tolerances associated with forward frame assembly 214, predrilled holes or pre-welded supports could deviate from the design position by enough to cause misalignment of electronic steering assist unit 220 that introduces torque pre-load on electronic steering assist unit 220 when electronic steering assist unit 220 is coupled to spars 214a, 214b at such predrilled holes or pre-welded supports. The use of floating mounting system 240 prevents such misalignment, and thus torque pre-load on electronic steering assist unit 220 when electronic steering assist unit 220 is coupled to spars 214a, 214b. It should be noted that the vertical position of clamp 246 on spar 214a is different than, and in this case higher than, the vertical position of clamp 252 on spar 214b. In the illustrated embodiment, once electronic steering assist unit 220 is clamped to spars 214a, 214b, electronic steering assist unit 220 is positioned forward of the engine with electric motor 220a of electronic steering assist unit 220 is positioned forward of spars 214a, 214b, as best seen in FIG. 4D. In addition, electric motor 220a of electronic steering assist unit 220 is positioned generally above the engine, forward of the muffler, above an inlet to an exhaust duct of the exhaust system, outboard of the inlet to an exhaust duct and/or within a curved portion of the exhaust duct. Further, at least a portion of electronic steering assist unit 220 is positioned forward of aftward mounting point 270b, 274b of upper A-arms 270, 274 and forward of aftward mounting point 272b, 276b of lower A-arms 272, 276.

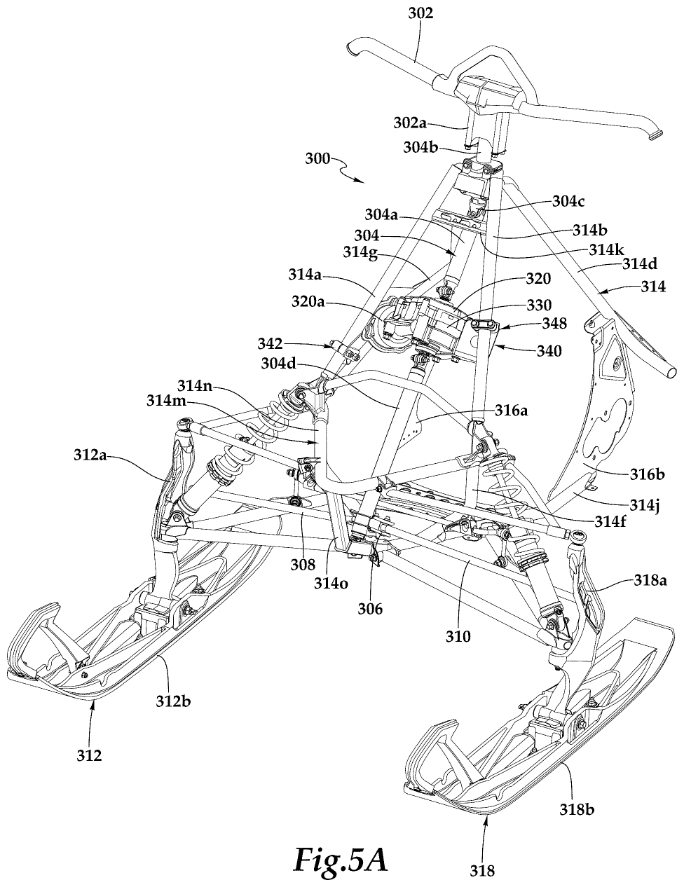

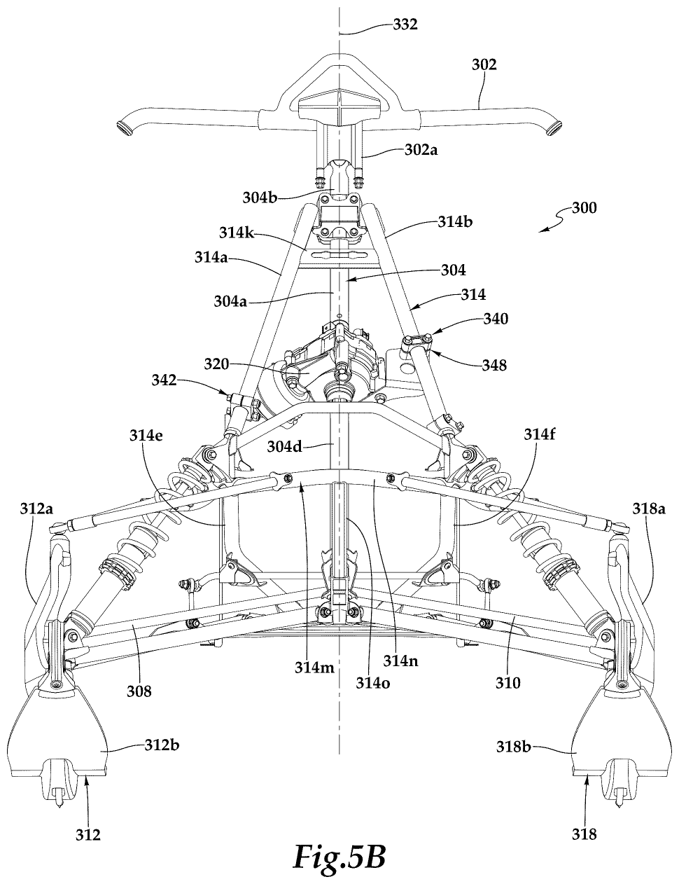

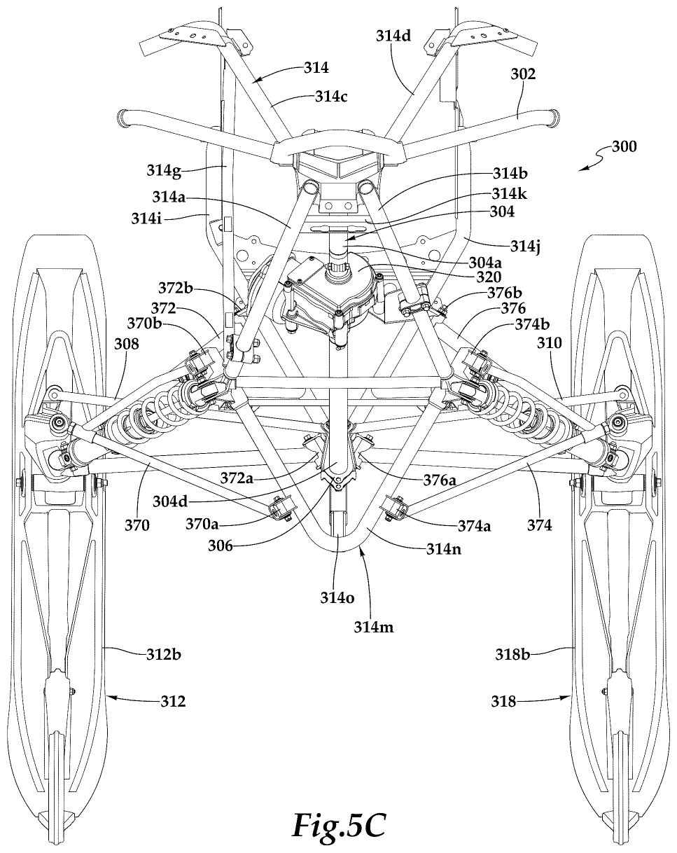

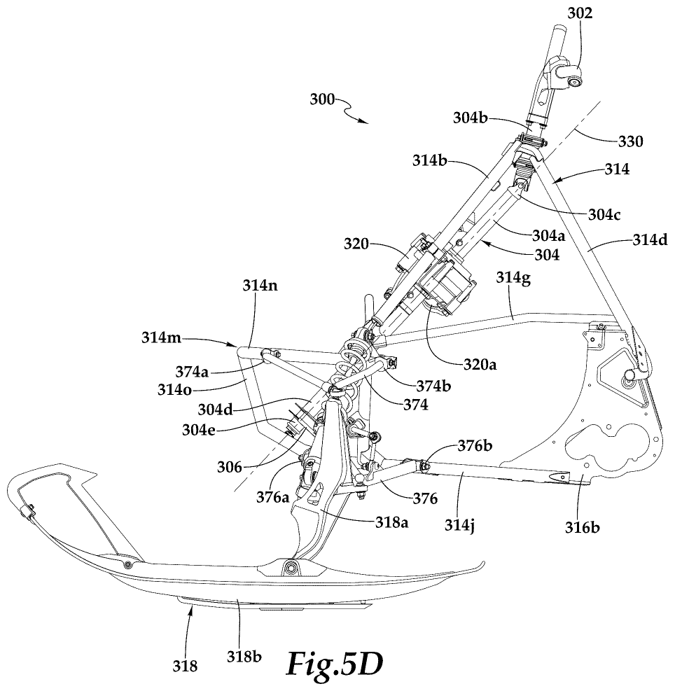

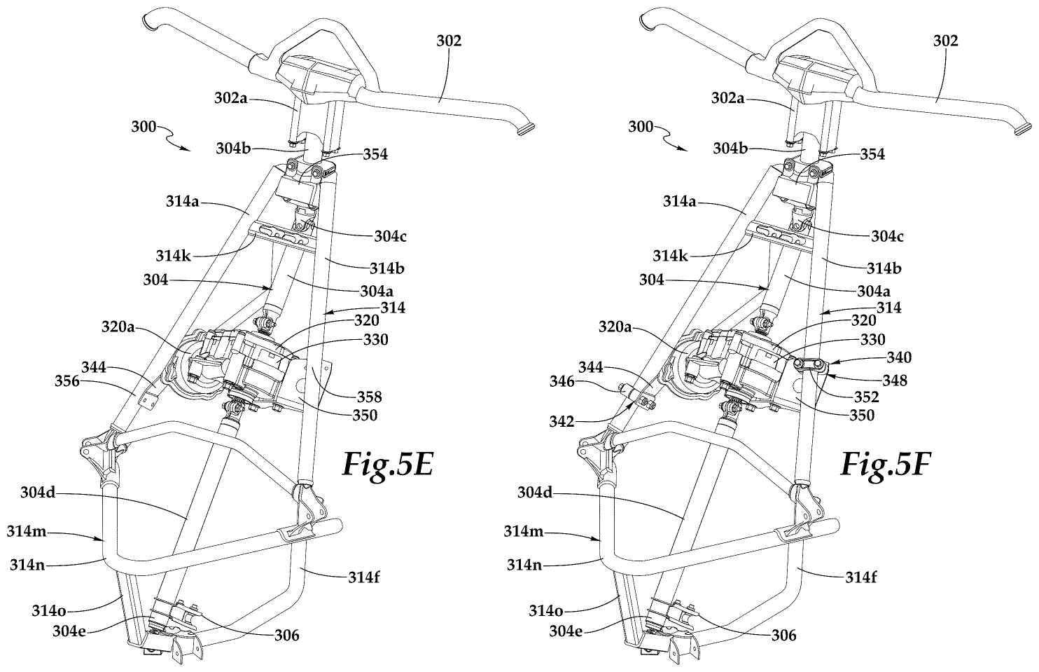

Referring now to FIGS. 5A-5F of the drawings, an embodiment of a steering system for a snowmobile, such as snowmobile 10 or a snowmobile having a two-stroke engine that is aftwardly tilted and has air intake inlets on the aftward side of the engine and exhaust outlets on the forward side of the engine, will now be discussed. Steering system 300 includes a handlebar assembly 302, a steering column 304, a steering arm assembly 306, a right tie rod 308, a left tie rod 310, a right ski assembly 312 including a right spindle 312a and a right ski 312b, and a left ski assembly 318 including a left spindle 318a and a left ski 318b. In addition, steering system 300 includes an electronic steering assist unit 320. Steering system 300 is coupled to a forward frame assembly 314 that includes a right-forward spar 314a, a left-forward spar 314b, a right-aft spar 314c, a left-aft spar 314d, right truss 314e, a left truss 314f, a right-upper beam 314g, a left-upper beam (not installed in the illustrated embodiment), a right-lower beam 314i, a left-lower beam 314j, an upper cross member 314k and a nose frame assembly 314m including a nose rail 314n and a nose truss 314o. Plate members 316a, 316b are coupled to and preferably welded to forward frame assembly 314 such that forward frame assembly 314 and plate members 316a, 316b form a welded frame assembly. Right ski assembly 312 is coupled to forward frame assembly 314 by an upper A-arm 370 at forward and aftward mounting points 370a, 370b and by a lower A-arm 372 at forward and aftward mounting points 372a, 372b. Likewise, left ski assembly 318 is coupled to forward frame assembly 314 by an upper A-arm 374 at forward and aftward mounting points 374a, 374b and by a lower A-arm 376 at forward and aftward mounting points 376a, 376b.

In the illustrated embodiments, steering column 304 is a bent steering column formed from an upper post 304a that is positioned aft of upper cross member 314k, a handlebar post 304b that is coupled to upper post 304a via a universal joint 304c and a lower post 304d. Handlebar post 304b of steering column 304 has an upper end coupled to handlebar assembly 302 via a handlebar bracket 302a. A lower end of upper post 304a includes a splined coupler that receives an input shaft that has input splines therein to couple the lower end of upper post 304a to electronic steering assist unit 320. Lower post 304d of steering column 304 has an upper end that includes a splined coupler that receives an output shaft that has output splines therein to couple the upper end of lower post 304d to electronic steering assist unit 320. Steering arm assembly 306 is coupled to lower end 304e of lower post 304d. Steering arm assembly 306 is coupled to the proximal ends tie rods 308, 310. The distal ends of tie rods 308, 310 are respectively coupled to ski assemblies 312, 318 such that rotation of handlebar assembly 302 by the rider of the snowmobile, together with the assist of electronic steering assist unit 320, causes ski assemblies 312, 318 to pivot, thus turning the snowmobile. Lower end 304e of lower post 304d is received within a bearing assembly (not visible) of nose truss 3140 such that lower post 304d is operable to rotate relative thereto.

Electronic steering assist unit 320 includes an outer housing 330 that contains the working components thereof including, for example, an electric motor 320a, a torque sensor, a controller and a torsion bar that couples the input shaft to the output shaft of electronic steering assist unit 320. In operation, the input torque applied from handlebar assembly 302 via handlebar post 304b and upper post 304a on the input shaft of electronic steering assist unit 320 is measured by the torque sensor. Input torque data is then provided to the controller from the torque sensor. Based upon the input torque data and additional factors such as the speed of the snowmobile, the controller commands electric motor 320a to provide an output assist torque to the output shaft of electronic steering assist unit 320 that is additive to the input torque applied to the output shaft from the input shaft via the torsion bar. The use of electronic steering assist unit 320 improves the handling of the snowmobile, reduces fatigue associated with driving the snowmobile and can allow the snowmobile to be driven more aggressively. In addition, using steering system 300 that has a common axis of rotation 330 (see FIG. 5D) shared by steering column 304, electronic steering assist unit 320 and steering arm assembly 306 that is positioned along a centerline 332 (see FIG. 5B) of the snowmobile, reduces the number of parts required in steering system 300 and reduces the complexity of steering system 300, which improves the overall reliability of the snowmobile.

To prevent a torque pre-load on electronic steering assist unit 320, the present embodiment utilizes a floating mounting system 340 to couple electronic steering assist unit 320 to forward spars 314a, 314b. Floating mounting system 340 includes a right floating clamp assemblies 342 that is formed from a right mounting bracket 344 and a right clamp 346, and a left floating clamp assemblies 348 that is formed from a left mounting bracket 350 and a left clamp 352 wherein, clamps 346, 352 are depicted as pillow block clamps. During installation, steering column 304, electronic steering assist unit 320 and steering arm assembly 306 are preferably preassembled then positioned along centerline 332 of the snowmobile with lower end 304e of lower post 304d received within a bearing assembly (not visible) of nose truss 3140 and handlebar post 304b received on an aftward side of steering column mount 354, as best seen in FIG. 5E. Right mounting bracket 344 and left mounting bracket 350 may be part of the preassembly or may be bolted on to outer housing 330 of electronic steering assist unit 320 after steering column 304, electronic steering assist unit 320 and steering arm assembly 306 have been received by forward frame assembly 314. In either case, once coupled to electronic steering assist unit 320, right mounting bracket 344 aligns with a nonpredetermined location 356 of right-forward spar 314a and left mounting bracket 350 aligns with a nonpredetermined location 358 of left-forward spar 314b.

Next, right clamp 346 is used to couple right mounting bracket 344 to right-forward spar 314a at nonpredetermined location 356 and left clamp 352 is used to couple left mounting bracket 350 to left-forward spar 314b at nonpredetermined location 358, as best seen in FIG. 5F. In the clamped orientation, outer housing 330 is fixed against rotation relative to forward frame assembly 314. As nonpredetermined locations 356, 358 that clamps 346, 352 couple brackets 344, 350 to spars 314a, 314b are not constrained by predrilled holes or pre-welded supports, torque pre-load caused by misalignment of electronic steering assist unit 320 is prevented. It should be noted that the vertical position of clamp 346 on spar 314a is different than, and in this case lower than, the vertical position of clamp 352 on spar 314b. In the illustrated embodiment, once electronic steering assist unit 320 is clamped to spars 314a, 314b, electronic steering assist unit 320 is positioned forward of the engine with electric motor 320a of electronic steering assist unit 320 is positioned aftward of spars 314a, 314b, as best seen in FIG. 5D. In addition, electric motor 320a of electronic steering assist unit 320 is positioned generally above the engine, between the muffler and steering column 304, above an inlet to an exhaust duct of the exhaust system and/or closer to an outlet of the exhaust duct than the inlet of the exhaust duct. Further, at least a portion of electronic steering assist unit 320 is positioned forward of aftward mounting points 372b, 376b of lower A-arms 372, 376.

Forward frame assembly 214 of FIGS. 4A-4G and forward frame assembly 314 of FIGS. 5A-5F may represent a common forward frame assembly used as part of multiple snowmobile models that have different configurations. As illustrated herein, for example, steering system 200 of FIGS. 4A-4G includes straight steering column 204 that is positioned forward of upper cross member 214k and forward of steering column mount 254 that may be preferable for high performance snowmobiles while steering system 300 of FIGS. 5A-5F includes a bent steering column 304 that is positioned aft of upper cross member 314k and aft of steering column mount 354 that may be preferrable for mountain snowmobiles.

The foregoing description of embodiments of the disclosure has been presented for purposes of illustration and description. It is not intended to be exhaustive or to limit the disclosure to the precise form disclosed, and modifications and variations are possible in light of the above teachings or may be acquired from practice of the disclosure. The embodiments were chosen and described in order to explain the principals of the disclosure and its practical application to enable one skilled in the art to utilize the disclosure in various embodiments and with various modifications as are suited to the particular use contemplated. For example, numerous combinations of the features disclosed herein will be apparent to persons skilled in the art including the combining of features described in different and diverse embodiments, implementations, contexts, applications and/or figures. Other substitutions, modifications, changes and omissions may be made in the design, operating conditions and arrangement of the embodiments without departing from the scope of the present disclosure. Such modifications and combinations of the illustrative embodiments as well as other embodiments will be apparent to persons skilled in the art upon reference to the description. It is, therefore, intended that the appended claims encompass any such modifications or embodiments.

What is claimed is:

1. A steering system for a snowmobile, the steering system comprising:
a handlebar assembly;
a steering column having upper and lower ends, the upper end of the steering column coupled to the handlebar assembly;
an electronic steering assist unit having input and output shafts, the input shaft coupled to the lower end of the steering column;
a steering arm assembly coupled directly to the output shaft of the electronic steering assist unit;
a first tie rod having proximal and distal ends, the proximal end of the first tie rod coupled to the steering arm assembly;
a second tie rod having proximal and distal ends, the proximal end of the second tie rod coupled to the steering arm assembly;
a first ski assembly coupled to the distal end of the first tie rod; and
a second ski assembly coupled to the distal end of the second tie rod;
wherein, the steering column and the electronic steering assist unit share a common axis of rotation that is positioned along a centerline of the snowmobile.

2. The steering system as recited in claim 1 wherein, the snowmobile includes a forward frame assembly; and
wherein, the electronic steering assist unit is coupled to the forward frame assembly.

3. The steering system as recited in claim 1 wherein, the snowmobile includes a forward frame assembly;
wherein, the forward frame assembly includes a nose frame assembly defining an electronic steering assist unit bay; and
wherein, the electronic steering assist unit is at least partially positioned within the electronic steering assist unit bay.

4. The steering system as recited in claim 1 wherein, the snowmobile includes a heat exchanger; and
wherein, the electronic steering assist unit is positioned below of the heat exchanger.

5. The steering system as recited in claim 1 wherein, the snowmobile includes an engine; and
wherein, the electronic steering assist unit is positioned forward of the engine.

6. The steering system as recited in claim 1 wherein, the snowmobile includes an engine and a heat exchanger;
wherein, the heat exchanger and the electronic steering assist unit are positioned forward of the engine; and
wherein, the electronic steering assist unit is positioned below of the heat exchanger.

7. The steering system as recited in claim 1 wherein, the snowmobile includes a forward frame assembly and an engine;
wherein, the forward frame assembly includes a lower cross member that is positioned between the engine and the electronic steering assist unit;
wherein, the engine is coupled to the lower cross member; and
wherein, the electronic steering assist unit is coupled to the lower cross member.

8. The steering system as recited in claim 7 wherein, the engine is coupled to the lower cross member via first and second engine mounts; and
wherein, the electronic steering assist unit is coupled to the lower cross member via a mounting bracket that is positioned between the first and second engine mounts.

9. The steering system as recited in claim 1 wherein, the snowmobile includes a forward frame assembly;
wherein, the forward frame assembly includes a nose frame assembly and a lower cross member; and
wherein, the electronic steering assist unit is coupled between the nose frame assembly and the lower cross member.

10. A snowmobile comprising:
a chassis including a forward frame assembly;
an engine coupled to the forward frame assembly;
a handlebar assembly;
a steering column having upper and lower ends, the upper end of the steering column coupled to the handlebar assembly;
an electronic steering assist unit coupled to the forward frame assembly, the electronic steering assist unit having input and output shafts, the input shaft coupled to the lower end of the steering column;
a steering arm assembly coupled directly to the output shaft of the electronic steering assist unit;
a first tie rod having proximal and distal ends, the proximal end of the first tie rod coupled to the steering arm assembly;
a second tie rod having proximal and distal ends, the proximal end of the second tie rod coupled to the steering arm assembly;
a first ski assembly coupled to the distal end of the first tie rod; and
a second ski assembly coupled to the distal end of the second tie rod;
wherein, the steering column and the electronic steering assist unit share a common axis of rotation that is positioned along a centerline of the snowmobile.

11. The snowmobile as recited in claim 10 wherein, the engine is an aftwardly tilted four-stroke engine.

12. The snowmobile as recited in claim 10 wherein, the forward frame assembly includes a lower cross member that is positioned between the engine and the electronic steering assist unit;
wherein, the engine is coupled to the lower cross member via first and second engine mount; and
wherein, the electronic steering assist unit is coupled to the lower cross member via a mounting bracket that is positioned between the first and second engine mounts.

13. The snowmobile as recited in claim 10 wherein, the forward frame assembly includes a nose frame assembly defining an electronic steering assist unit bay;
wherein, the electronic steering assist unit is at least partially positioned within the electronic steering assist unit bay; and
wherein, the electronic steering assist unit is coupled to the nose frame assembly.

14. The snowmobile as recited in claim 10 further comprising a heat exchanger coupled to the forward frame assembly;
wherein, the heat exchanger and the electronic steering assist unit are positioned forward of the engine; and
wherein, the electronic steering assist unit is positioned below of the heat exchanger.

15. A snowmobile comprising:
a forward frame assembly defining an engine bay and an electronic steering assist unit bay positioned forward of the engine bay;
an engine positioned in the engine bay;
a tunnel coupled to the forward frame assembly, the tunnel positioned aft of the engine bay;
a steering system including a handlebar assembly, a steering column and a steering arm assembly, the steering column having a first end coupled to the handlebar assembly and a second end extending forward and downward from the first end;
an electronic steering assist unit at least partially positioned in the electronic steering assist unit bay, the electronic steering assist unit including an input shaft coupled to the second end of the steering column and an output shaft coupled to the steering arm assembly; and
a heat exchanger positioned above the electronic steering assist unit bay and forward of the engine bay.

16. The snowmobile as recited in claim 15 wherein, the forward frame assembly includes a nose frame assembly that at least partial defines the electronic steering assist unit bay;
wherein, the forward frame assembly includes a cross member positioned between the engine bay and the electronic steering assist unit bay; and
wherein, the engine and the electronic steering assist unit are each coupled to the cross member.

17. The snowmobile as recited in claim 16 wherein, the nose frame assembly includes forward upper A-arm mounts and aft upper A-arm mounts; and
wherein, the heat exchanger and at least a portion of the electronic steering assist unit are positioned between the forward upper A-arm mounts and the aft upper A-arm mounts.

18. The snowmobile as recited in claim 16 wherein, the electronic steering assist unit includes a motor; and
wherein, the motor is positioned at a forward end of the nose frame assembly.

19. The snowmobile as recited in claim 18 wherein, the motor at least partially extends above the electronic steering assist unit bay and forward of the heat exchanger.

20. The snowmobile as recited in claim 15 wherein, the steering column extends along a centerline of the vehicle; and
wherein, the electronic steering assist unit is positioned along the centerline of the vehicle.
